(19) United States
(12) Patent Application Publication
(10) Pub. No.: US 2007/0143978 A1
(43) Pub. Date: Jun. 28, 2007

(54) Valve core remover and installation tool

(76) Inventor: Curtis Matthew Stewart, Sugarloaf, CA (US)

Correspondence Address: Curtis Matthew Stewart, P.O. Box 6017, Big Bear Lake, CA, 92315, US

(21) Appl. No.: 11/633,099

(22) Filed: Dec. 4, 2006

Related U.S. Application Data
(60) Provisional application No. 60/742,257, filed on Dec. 6, 2005.

(51) Int. Cl. B23P 19/04

(52) U.S. Cl. 29/221.5

(57) ABSTRACT

A tool used for removing and installing Schrader-type valve cores on all mounted or dismounted rims especially dual mounted rims. Tool consists of a handle portion that has a chamber which snaps over a valve stem, the forked shaft enters the valve stem and extracts the core simply by rotating the handle. Tool works for the inward pointed valve stem found on the outer rim of a dual. Tool can also extract at the opposite forked end of shaft which extends from the top of the handle and works for the inner mounted rim of a dual or any other Schrader-type valves.

### REFERENCES CITED

| | | |
|---|---|---|
| 652232 | June 1900 | Culp |
| 1076981 | October 1913 | Hard |
| 1393365 | October 1921 | Heil |
| 2092941 | September 1937 | Trefney Etal |
| 2096676 | October 1937 | Conrad |
| 2320042 | May 1943 | Mc Mahan |
| 2417360 | March 1947 | Heintzelman |
| 2679654 | June 1954 | Hosking |
| 2709383 | May 1955 | Davies |
| 3100335 | August 1963 | Lea |
| 3208133 | September 1965 | Morton |
| 3561090 | February 1971 | Fritch |
| 3718057 | February 1973 | Berchtold |
| 3840967 | October 1974 | Olson |
| 3852839 | December 1974 | Blessing |
| 3861249 | January 1975 | Linquist |
| 3935713 | February 1976 | Olson |
| 6152165 | November 2000 | Fukuda |
| 6612005 | September 2003 | Rivers |
| 6862787 | March 2005 | Groves |
| 6944924 | September 2005 | Hayes |

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Field of the Invention

The present invention relates to a tool for installing and removing Schrader-type valve cores on dual mounted rims, particularly to tools for use with Schrader-type pneumatic tire valve cores.

2. Relevant Art

[a]Many tools exist for the use with tire valves. What is needed is a tool specifically for use in removing and installing a valve core in a valve stem assembled to an outer dual rim. The tool should fit onto and/or into a valve stem, and therefore be usable as a tool for valve core removal and installation particularly for Schrader-type pneumatic tire valves. It often becomes necessary to remove the valve core because of a leak caused by rust, dirt, seal failure, mechanical core failure, or simply creates a faster way to add or deplete air pressure.

[b]Some rims have different patterns and openings, and some valve stems have different lengths, making it difficult to get a tool on most of them. If a mechanic cannot fit his hands between the dual tires to remove the outer rim valve core from the valve stem, then he would have to dismount the rim completely from the hub, wasting time. This tool makes it easier and faster to remove or install a valve core, ultimately speeding up repair time, shop production, company costs, and getting drivers back on the road quicker.

### BRIEF DESCRIPTION OF THE SEVERAL VIEWS OF THE DRAWING

FIG. 1 is a side view of the valve stem core tool in accord with the present invention;

FIG. 2 is a bottom view of the tool of FIG. 1;

FIG. 3 is a top view of the tool of FIG. 1.

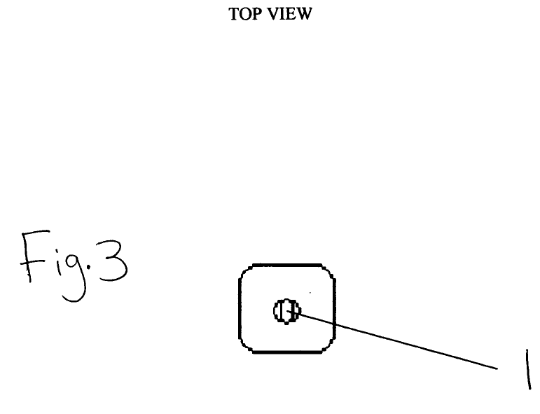

FIG. 4 is a view of the shaft without handle.

### BRIEF SUMMARY OF THE INVENTION

This present invention allows for the installation and removal of a Schrader-type valve core in a valve stem on the outside dual mounted rim without removal of rim from hub or axle. Dual mounted rims are two rims mounted together on an axle or hub. Dual mounted rims can be found on semi trucks, trailers, pickups, utility trucks, service trucks, dump trucks, buses, etc. The chamber of the handle is placed onto the valve stem and the extraction shaft is then automatically aligned with the center of the valve stem and enables the shafts' forked end to slide into and engage with the valve core.

Simply by rotating the tool around the valve stem, the bottom end of the shafts' forked portion can extract the core. This tool was primarily designed to make it easier for the removal and installation of a Schrader-type valve core in a valve stem that is assembled to the outer rim of a dually, in which case the valve stem protrudes into the rim opening, toward the inner rim.

### DETAILED DISCIPTION OF THE INVENTION

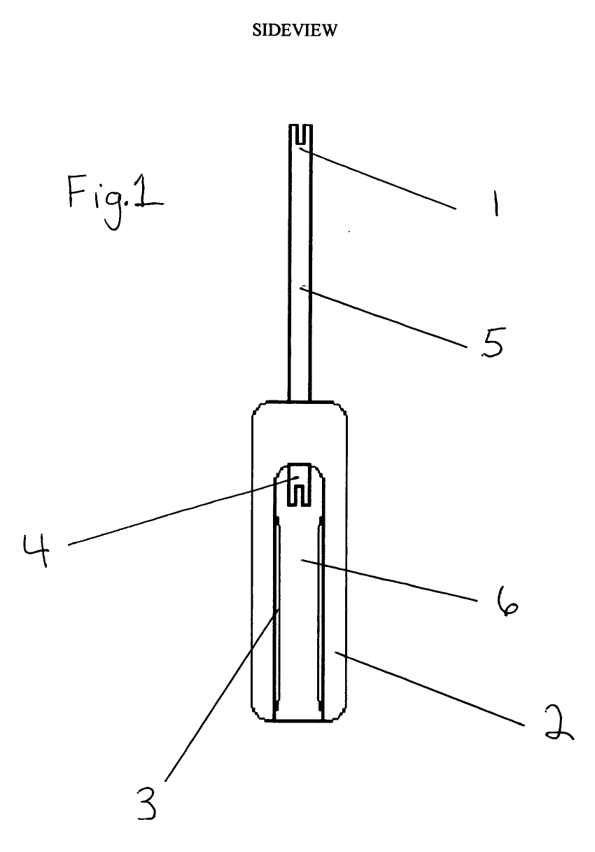

A tool used for the extraction of a Schrader-type valve core from a valve stem and is designed to extract valve cores from valve stems in rims of dual wheeled vehicles as illustrated in FIG. 1. The tool is made up of a handle 2 and a shaft 5. The handle 2 works with the shaft 5 to create a functional tool. The handle 2 can be textured for grip and has rounded edges for comfort in the hand. The handle 2 can be manufactured from plastic, metal, wood, fiberglass, resin, rubber, a combination of these materials, or any other materials that can be processed to make a handle portion. The shaft 5 can be manufactured from metal including but not limited to steel or any other alloys to make a shaft portion. The top of shaft 1 is one of two extraction forks used for the majority of Schrader-type valve cores. The shaft 5 enters a hole at the center of the top of the handle portion and then exits into the chamber 6 of the handle 2. This end of the shaft 4 is the second extraction fork.

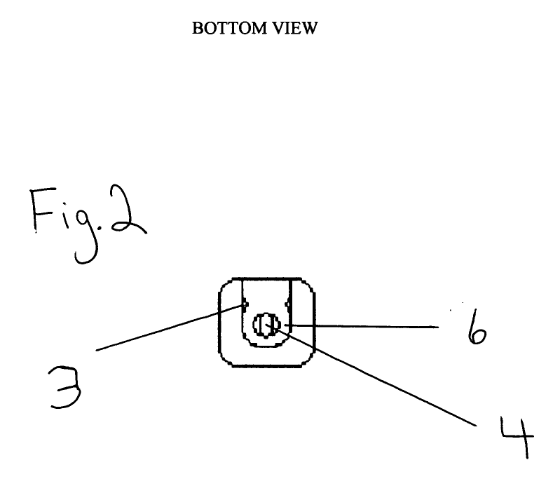

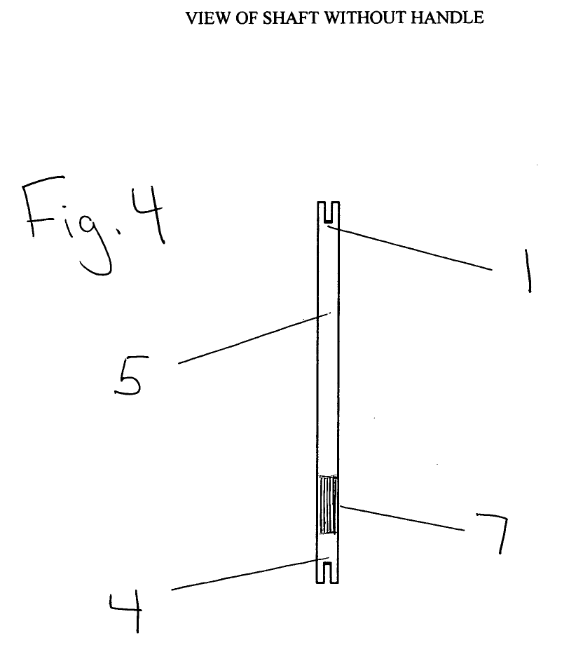

The knurl 7 on the shaft in illustration FIG. 4 keeps the shaft in place and allows for the tool to torque adequately. The chamber 6 is open to one side of the handle as illustrated in FIG. 2. The other three sides of the handle are solid with no chambers or holes. The bottom of the handle illustrated in FIG. 2 is one point where a valve stem can enter the chamber 6 of the tool. The side of the handle illustrated in FIG. 1 is another point where the valve stem can enter the chamber 6 of the tool. There is an offset 3 at this entrance point which allows the tool to snap over the stem and keeps the tool and stem aligned. At this time of alignment, the extraction shaft 4 and valve core are also aligned. This allows for the extraction shaft to be inserted into the stem and engage with the valve core. The offset 3 also keeps the tool from falling of the valve stem when using.

1. A tool for installing and removing a Schrader-type valve core from a Schrader-type valve stem comprising of a handle with affixed shaft, said handle having a chamber to align the valve stem and core with said shaft, said handle having a hole for the shaft to be affixed, said shaft comprising of same opposite forked valve core engagement ends, said shaft having a knurl to mate, with the inside of said hole, said handle having about two valve stem entrances to said chamber, one on the side of said handle and one at the bottom of the handle, said chamber having an offset to allow said handle to snap onto said valve stem and keeps said tool is used by rotating said handle around said valve stem in said chamber while the forked end engages with said valve core and can also be used by rotating said handle for the use of the top forked end portion in engagement with said valve core.

2. The tool as defined in claim 1 wherein said chamber can be concave, rectangular, triangular or any other shape that will allow said handle to have a chamber.

3. The tool as defined in claim 1 wherein said handle can be rectangular in shape having rounded corners and can be textured to allow user to grasp and rotate said tool easier and with comfort.

4. The tool as defined in claim 1 can be used many ways to extract, install, remove, or engage with said valve core in said valve stem.

5. The tool as defined in claim 1 wherein said shaft comprising of two forked end portions are machined to conform to said valve core in said valve stem, said shaft having said knurl to allow said shaft to tightly grasp said hole of said handle.

6. The tool as defined in claim 3 wherein said tool can install or remove Schrader-type pneumatic valve cores in Schrader-type pneumatic valve stems by engaging the top forked end portion of said shaft with said valve core and by using said tool similar to a screwdriver.

7. The tool as defined in claim 3 wherein said tool can install or remove Schrader-type pneumatic valve cores in Schrader-type pneumatic valve stems assembled to an outer dual mounted rim by sliding, snapping, or clipping said chamber of said tool over or onto said valve stem and engaging the bottom forked end portion of said shaft with said valve core then rotating said handle around said valve stem.
